(19) United States
(12) Patent Application Publication
(10) Pub. No.: US 2005/0031823 A1
(43) Pub. Date: Feb. 10, 2005

(54) Low cost conductive labels manufactured from conductive loaded resin-based materials

(75) Inventor: Thomas Aisenbrey, Littleton, CO (US)

Correspondence Address: GEORGE O. SAILE, 28 DAVIS AVENUE, POUGHKEEPSIE, NY, 12603, US

(73) Assignee: Integral Technologies, Inc.

(21) Appl. No.: 10/930,352

(22) Filed: Aug. 31, 2004

Related U.S. Application Data
(63) Continuation-in-part of application No. 10/309,429, filed on Dec. 4, 2002.
Application No. 10/309,429 is a continuation-in-part of application No. 10/075,778, filed on Feb. 14, 2002, now Pat. No. 6,741,221.
(60) Provisional application No. 60/499,450, filed on Sep. 2, 2003.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. B32B 9/00

(52) U.S. Cl. 428/40.1; 428/195.1

(57) ABSTRACT

Conductive labels useful for anti-static devices are formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are formed from non-metals, such as carbon, graphite, that may also be metallic plated, or the like, or from metals such as stainless steel, nickel, copper, silver, that may also be metallic plated, or the like, or from a combination of non-metal, plated, or in combination with, metal powders. The micron conductor fibers preferably are of nickel plated carbon fiber, stainless steel fiber, copper fiber, silver fiber, or the like.

This Patent Application claims priority to the U.S. Provisional Patent Application 60/499,450, filed on Sep. 2, 2003, which is herein incorporated by reference in its entirety.

This Patent Application is a Continuation-in-Part of INT01-002CIP, filed as U.S. patent application Ser. No. 10/309,429, filed on Dec. 4, 2002, also incorporated by reference in its entirety, which is a Continuation-in-Part application of docket number INT01-002, filed as U.S. patent application Ser. No. 10/075,778, filed on Feb. 14, 2002, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001.

### BACKGROUND OF THE INVENTION

(1) Field of the Invention

This invention relates to conductive, or anti-static, labels molded of conductive loaded resin-based materials comprising micron conductive powders, micron conductive fibers, or a combination thereof, homogenized within a base resin when molded. This manufacturing process yields a conductive part or material usable within the EMF or electronic spectrum(s).

(2) Description of the Prior Art

Many electronic devices, also known as electronic components, such as integrated circuits (ICs), are sensitive to electrostatic discharge (ESD). ESD is caused by the build-up of static charge resulting in voltage potentials of many thousands of volts. When a discharge event, such as merely handling a component, occurs, then a very short but intense pulse of energy is released. Although most electronic components are designed to provide discharge paths for this energy, it is highly preferred to avoid exposing the components to this energy pulse.

Therefore, throughout the fabrication, transportation, storage, and dispensing of electronic components, it is critical that electronic components be protected from experiencing ESD. If these electronic devices are subjected to ESD, they may become damaged and unusable in their intended application. Containers are widely used to accommodate the transportation, storage, and dispensing of electronic components sensitive to ESD. It is important that electronic component containers dissipate electrostatic charge and thereby prevent the accumulation of potentially damaging static charges.

In addition to the containment of electronic components, it is also important that containers of certain other items be electrically conductive. For example, barrels, jugs, and other containers used to house hazardous materials must not transmit ESD to their potentially flammable contents. Likewise, the labels used on surfaces of anti-static containers must not allow ESD to occur. For this reason, conductive loaded resin-based material labels of the present invention are ideal for labeling containers which house ESD sensitive devices and/or containers which house hazardous materials. These conductive loaded resin-based material labels provide a low cost, high reliability alternative to conventional labels found in the art.

Several prior art inventions relate to conductive, or anti-static, labels. U.S. Pat. No. 6,562,428 B1 to Ohrui teaches an antistatic adhesive sheet that utilizes a high molecular type quaternary ammonium salt as the anti static agent in the resin film.

U.S. Pat. No. 6,497,933 B1 to Yeager et al teaches an antistatic composition for use in a label construction that utilizes an antistatic coating on the release liner to reduce static build up when labels are stacked or rolled together.

U.S. Pat. No. 5,700,623 to Anderson et al teaches a thermally stable bar code label for use on articles that are exposed to high temperatures during a manufacturing process. This invention also teaches an antistatic layer comprising conductive antimony-doped tin oxide particles in the polymer matrix.

U.S. Pat. No. 6,569,494 B1 to Chambers et al teaches a method and apparatus for making particle-embedded webs. This invention also teaches a method of embedding conductive particles into a film and then curing the film.

### SUMMARY OF THE INVENTION

A principal object of the present invention is to provide an effective conductive label.

A further object of the present invention is to provide a method to form a conductive label.

A further object of the present invention is to provide a conductive label molded of conductive loaded resin-based materials.

A yet further object of the present invention is to provide a conductive label molded of conductive loaded resin-based materials wherein the conductive loaded resin-based material provides a means of preventing and/or dissipating electrostatic charge such that devices and/or substances in contact with the label are protected against ESD.

A yet further object of the present invention is to provide a conductive label molded of conductive loaded resin-based material where the electrical characteristics can be altered or the visual characteristics can be altered by forming a metal layer over the conductive loaded resin-based material.

A yet further object of the present invention is to provide methods to fabricate a conductive label from a conductive loaded resin-based material incorporating various forms of the material.

A yet further object of the present invention is to provide a method to fabricate a conductive label from a conductive loaded resin-based material where the material is in the form of a fabric.

In accordance with the objects of this invention, a conductive label device is achieved. The conductive label comprises a conductive loaded, resin-based material comprising conductive materials in a base resin host. The conductive loaded, resin-based material is capable of conducting electrical charge or current. Informative shapes are affixed to the conductive loaded, resin-based material.

Also in accordance with the objects of this invention, a conductive label device is achieved. The conductive label comprises a conductive loaded, resin-based material comprising conductive materials in a base resin host. The conductive loaded, resin-based material is capable of conducting electrical charge or current. Informative shapes are affixed to the conductive loaded, resin-based material. The percent by weight of the conductive materials is between about 20% and about 50% of the total weight of the conductive loaded resin-based material.

Also in accordance with the objects of this invention, a method to form a conductive label device is achieved. The method comprises providing a conductive loaded, resin-based material comprising conductive materials in a resin-based host. The conductive loaded, resin-based material is molded into the conductive label device. Informative shapes are affixed to said conductive loaded, resin-based material.

### BRIEF DESCRIPTION OF THE DRAWINGS

In the accompanying drawings forming a material part of this description, there is shown:

FIG. 1 illustrates a first preferred embodiment of the present invention showing a conductive ESD warning label comprising a conductive loaded resin-based material.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold anti-static labels of a conductive loaded resin-based material.

FIG. 7 illustrates another preferred embodiment of the present invention showing a conductive label comprising a conductive loaded resin-based material. In this embodiment, the conductive label displays useful information specific to the contents of the item being labeled.

FIG. 8 illustrates an enlarged side view of a conductive label comprising conductive loaded resin-based material.

FIG. 9 illustrates a strip of conductive labels comprising conductive loaded resin-based material.

FIG. 10 illustrates conductive labels comprising conductive loaded resin-based material and a dispenser used to singulate these labels for application to a surface.

FIG. 11 illustrates one application for a conductive label comprising conductive loaded resin-based material. The conductive label therein is adhered to a conductive or anti-static bin or tray.

FIG. 12 illustrates another application for a conductive label comprising conductive loaded resin-based material. The conductive label therein is adhered to a conductive or anti-static box.

FIG. 13 illustrates yet another application for a conductive label comprising conductive loaded resin-based material. In this application, the conductive label of the present invention is adhered directly to a product device.

### DESCRIPTION OF THE PREFERRED EMBODIMENTS

This invention relates to conductive labels molded of conductive loaded resin-based materials comprising micron conductive powders, micron conductive fibers, or a combination thereof, homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are homogenized within the resin during the molding process, providing the electrical continuity.

The conductive loaded resin-based materials can be molded, extruded or the like to provide almost any desired shape or size. The molded conductive loaded resin-based materials can also be cut or stamped from an injection molded or extruded sheet or bar stock, over-molded, laminated, milled or the like to provide the desired shape and size. The thermal or electrical conductivity characteristics of conductive labels fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the conductive labels are homogenized together using molding techniques and or methods such as injection molding, over-molding, insert molding, thermo-set, protrusion, extrusion or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

The use of conductive loaded resin-based materials in the fabrication of conductive labels significantly lowers the cost of materials and the design and manufacturing processes used to hold ease of close tolerances, by forming these materials into desired shapes and sizes. The labels can be manufactured into infinite shapes and sizes using conventional forming methods such as injection molding, over-molding, vacuum-forming, or extrusion or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are homogenized together within the base resin, during the molding process, yielding an easy to produce low cost, electrically conductive, close tolerance manufactured part or circuit. The micron conductive powders can be of carbons, graphites, amines or the like, and/or of metal powders such as nickel, copper, silver, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. The micron conductive fibers can be nickel plated carbon fiber, stainless steel fiber, copper fiber, silver fiber, or the like, or combinations thereof. The structural material is a material such as any polymer resin. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, NY., or other flexible resin-based rubber compounds produced by other manufacturers.

The resin-based structural material loaded with micron conductive powders, micron conductive fibers, or in combination thereof can be molded, using conventional molding methods such as injection molding or over-molding, vacuum-forming, or extrusion to create desired shapes and sizes. The molded conductive loaded resin-based materials can also be stamped, cut or milled as desired to create the desired shape form factor(s) of the conductive label. The doping composition and directionality associated with the micron conductors within the loaded base resins can affect the electrical and structural characteristics of the conductive label, and can be precisely controlled by mold designs, gating and/or protrusion design(s) and/or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming conductive labels as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in anti-static label applications as described herein.

The homogeneous mixing of micron conductive fiber and/or micron conductive powder and base resin described in the present invention may also be described as doping. That is, the homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the homogeneous mixing of micron conductive fiber and/or micron conductive powder into a base resin.

As an additional and important feature of the present invention, the molded conductive loaded resin-based material exhibits excellent thermal dissipation characteristics. Therefore, labels manufactured from the molded conductive loaded resin-based material can provide added thermal dissipation capabilities to the application. For example, heat can be dissipated from electrical devices physically and/or electrically connected to a label of the present invention.

As a significant advantage of the present invention, conductive labels constructed of the conductive loaded resin-based material can be easily interfaced to an electrical circuit or, more importantly, grounded. In one embodiment, a wire can be routed under the conductive loaded resin-based label and then fastened to ground.

Referring now to conductive loaded resin-based material labels of the present invention, several important features are discussed below. The conductive loaded resin-based material provides an electrically conductive label which is intrinsically capable of safely dissipating electrostatic charge so that the label of the present invention cannot contribute to potential ESD damage. The conductive loaded resin-based material is highly conductive and is capable of high frequency response to provide an excellent energy dissipation path. The conductive label of the present invention is superior to conventional plastic labels in that conventional plastic labels are unable to provide ESD protection. The conductive label of the present invention is superior to a conductive metal label in that the conductive loaded resin-based material label is less costly to manufacture and is lower weight. The conductive loaded resin-based material of the present invention is uniquely formulated so as to provide a finished conductive label wherein the percent by weight of conductive materials is between about 20% and about 50% of the total weight of the conductive loaded resin-based material. This results in a superior balance between the characteristics of electrical conductivity, weight, manufacturability and cost. Further, the conductive loaded resin-based material labels of the present invention are clean room capable. They will not fray or release particles which cause cleanliness problems in stringent clean room environments.

Referring still to the advantageous features of conductive labels of the present invention, additional features are given below. In a preferred embodiment, these labels are formed of sheet material that remains flexible or pliable in its finished state. This flexibility makes the labels easy to manipulate. To a great extent, this flexibility further enables the conductive loaded resin-based material label to conform to the shape of the surface to which it is affixed. In an alternate embodiment, the conductive labels of the present invention are rigid. These rigid labels are shaped in conventional label shapes such as a relatively flat rectangular or nearly rectangular label. Alternately, the rigid conductive label is shaped into a useful object such as a container or product housing. The useful object is then printed with pertinent labeling information to form a label. In this alternate embodiment, the material and processing costs are further reduced by the elimination of the extra label component. However, in most applications, the preferred embodiment, discrete labels are used due to the convenience and processing expedience of the flexible label as a separate entity. Further advantages of the present invention include the fact that the conductive label is impervious to moisture. This means the label of the present invention maintains its physical and electrical integrity and legibility in moist environments. It is thus suitable for use in such conditions. Further, the conductive loaded resin-based material label is capable of maintaining its physical and electrical integrity and legibility over a wide range of temperatures. The host resin and conductive material are selected based on the temperature range requirement of the specific application.

As a significant advantage of the present invention, the electrically conductive composition of the label intrinsically prevents the buildup of static charges on the label. As has been discussed, this is critical in end-use label applications in that the label does not contribute to ESD. However, the intrinsic absence of static charge on the conductive label of the present invention is also advantageous during label manufacture. The absence of static charge on the surface of the label during label manufacturing results in reduced effective-coefficient of friction on the label surface. This aids in the production of labels. Even when labels are formed in strips or sheets and subsequently rolled or stacked, there is no buildup of electrostatic charge in the roll or stack. This is a significant advantage during label manufacture as well as during subsequent processing, shipping and field applications. Field applications include, but are not limited to, the removal of the label from a bulk roll, strip, or stack of labels and the affixing of the label to a component, assembly, or container. In field applications, conductive labels of the present invention are preferably affixed to conductive items or anti-static items such as conductive or anti-static containers, conductive housings on assemblies, or conductive components. Conductive containers include, but are not limited to, boxes, bags, trays, bins, barrels, jugs, housings, and the like formed of conductive loaded resin-based material. Conductive containers further include boxes, bags, trays, bins, barrels, jugs, housings, and the like formed of conductive metal or formed of other conductive materials.

An exemplary process for forming conductive loaded resin-based material labels of the present invention is described below. The conductive loaded resin-based material is heated and formed into a sheet. For example, extrusion and/or rolling are used to form the sheet of conductive loaded resin-based material. Once the conductive loaded resin-based material is cured, an adhesive is applied to the back of the sheet of conductive loaded resin-based material. The adhesive-side of the conductive loaded resin-based material sheet is joined to a release sheet. The release sheet is an “easy-release” type of backing which serves to keep the label from adhering to unwanted surfaces prior to the label being installed in the final application. The release sheet is designed to maintain minimal adhesive force between itself and the adhesive which coats the back of the label. Individual labels are created by printing the top surface of the conductive loaded resin-based material with pertinent information including text and/or graphics. In one preferred embodiment, the ink used for printing is a conductive ink. In an alternate embodiment, the ink is not a conductive ink. Prior to printing, if necessary to promote adhesion of the ink, the conductive loaded resin-based material is coated with an agent to increase the adhesiveness of the printing surface. However, this surface preparation is generally unnecessary due to the inherent electrically conductive property of the conductive loaded resin-based material sheet. The sheet of conductive loaded resin-based material is cut into individual labels. The release sheet preferably is cut or otherwise formed into long strips and/or sheets that support a plurality of individual labels on one continuous piece of release sheet. Alternately, the release sheet is cut such that one piece of release sheet supports only one individual label.

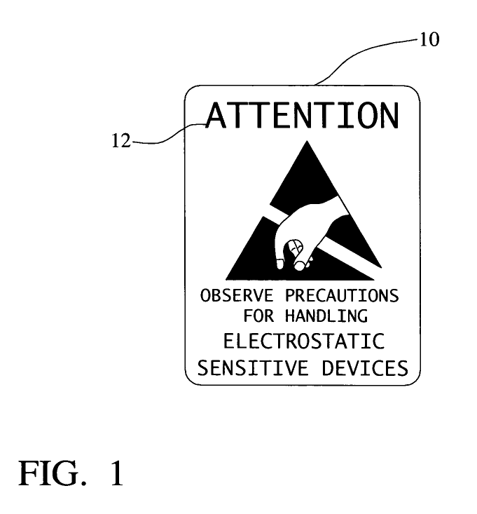

Referring now to FIG. 1, a first preferred embodiment of the present invention is illustrated. Several important features of the present invention are shown and discussed below. FIG. 1 illustrates a conductive loaded resin-based material label 10. The conductive label 10 comprises conductive loaded resin-based material, adhesive, not shown, and informative shapes 12. The informative shapes 12 are in the form of text and/or graphics/pictures. According to one embodiment, the informative shapes 12 are printed onto the conductive loaded resin-based material 10. Any known printing technique may be used. For example, screen printing, ink jet printing, laser printing, and the like, may be used to transfer an ink onto the surface of the conductive loaded resin-based material 10. According to another embodiment, the informative shapes 12 are molded into the conductive loaded resin-based material 10 during the molding process. According to another embodiment, the informative shapes 12 are embossed into the conductive loaded resin-based material 10 after molding a blank label 10. For example, a die stamp or tooling stamp, not shown, is used to press the informative shapes 12 into the blank label 10. Heating may be used to aid this process.

According to another embodiment, adhesive is used to affix the label 10 to another surface such as, for example, an anti-static or conductive container. The conductive label 10 as depicted in FIG. 1 serves to warn of the need to observe handling precautions for the ESD sensitive devices contained within the packaging. This adhesive layer may be conductive or non-conductive, though a conductive adhesive layer is preferred.

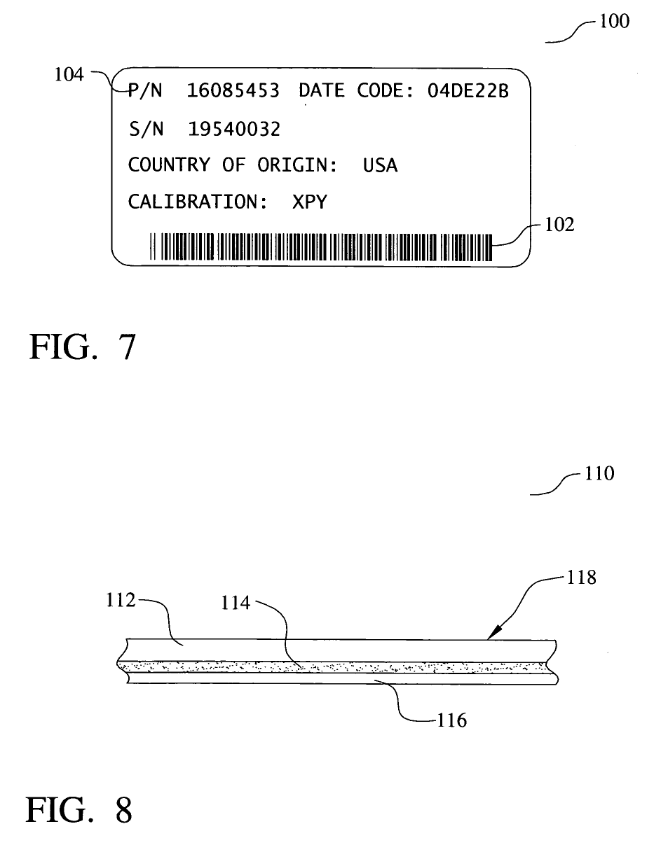

Referring now to FIG. 7, another preferred embodiment for a conductive label is shown. This label 100 displays useful product information specific to the contents of the container to which the label 100 is subsequently affixed. The displayed information contains text and/or graphics/pictures. As illustrated in FIG. 7, a barcode 102 is included in this information. Alternately, the label 100 does not include barcoded information 102. The text 104 which is printed on the conductive loaded resin-based material label 100 includes, but is not limited to, any of the following types of information: part number, serial number, country of origin, calibration, date code, size, quantity, product name, safe storage/handling information, and expiration date.

Referring now to FIG. 8, an enlarged side view of an exemplary conductive label 110 is illustrated. This side view shows one preferred embodiment for the construction of the conductive labels shown in FIGS. 1, 7, 9, and 10. Referring still to FIG. 8, layer 112 comprises conductive loaded resin-based material. This layer 112 provides the intrinsically electrically conductive property to the labels of the present invention. Layer 116 illustrates the release sheet which serves as a temporary backing for the conductive loaded resin-based material label. Layer 114 depicts the adhesive layer which is essentially sandwiched between the release sheet 116 and the conductive loaded resin-based material 112. In one embodiment, the adhesive 114 is a conductive adhesive. That is, the adhesive 114 is able to conduct electricity and thereby aid in the safe dissipation of electrostatic charges. In an alternate embodiment, the adhesive 114 is not conductive. The exact chemical formulation of the adhesive 114 is determined by the requirements of the particular end-use application. Many different properties of the adhesive 114 can be altered to meet these requirements. One such property that can be varied is the degree of adhesive force generated between the adhesive 114 and the specific surface the label is to be adhered to. Other adhesive properties which can be varied include, but are not limited to: thermal conductivity, electrical conductivity, chemical resistance, temperature range, and viscosity. The top surface 118 of the label 110 is also known as the printable surface 118. This is the surface upon which printed information, if any, is adhered to the conductive loaded resin-based material layer 112. In the most preferred embodiment of the present invention, the conductive label is comprised solely of these layers 116, 114, 112 and the printing on the surface 118. In other preferred embodiments, additional layers and compounds, not shown, are included in the conductive label 110. Such additional layers include, but are not limited to, laminates, non-conductive materials, materials which prepare the conductive loaded resin-based material 112 to better accept printing, and materials which protect the top surface 118 after printing is completed. The conductive loaded resin-based material 112 is available in many colors. The color of this conductive material 112 is selected based on the needs of the specific label application. As mentioned previously, the thermal properties of the host resin and micron conductive materials which make up the conductive loaded resin-based material are selected based on the needs of the specific label application.

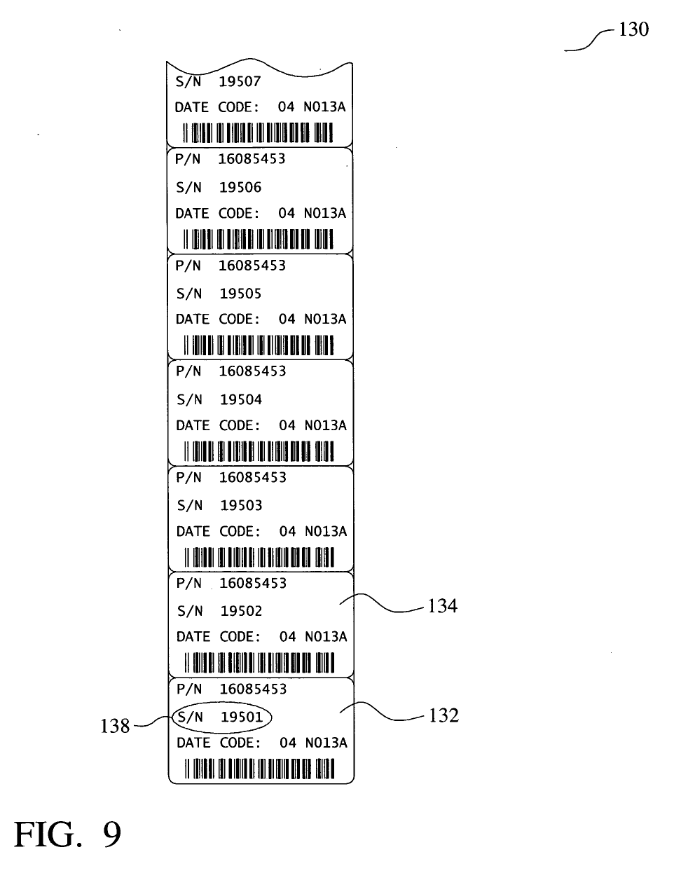

Referring now to FIG. 9, a series of adjacent labels 130 is shown. This may also be referred to as a strip of labels 130. These labels comprise conductive loaded resin-based material of the present invention. The individual labels, though separate from one another, remain in their adjacent positions due to their attachment to one common release sheet 136. The strip of labels 130 may subsequently be rolled, stacked, or otherwise stored compactly until application. In one preferred embodiment, the information printed on the label includes the serial number 138 which is abbreviated S/N. The first label 132 in the strip is given the lowest serial number which is unique to the individual product to which it will subsequently become affixed. The second label 134 in the strip is given the next sequential serial number. Likewise, the serial numbers increment sequentially throughout the strip of labels 130. Again, a wide variety of text and/or graphics/pictures are printed on the labels consistent with the information which is needed for the particular application.

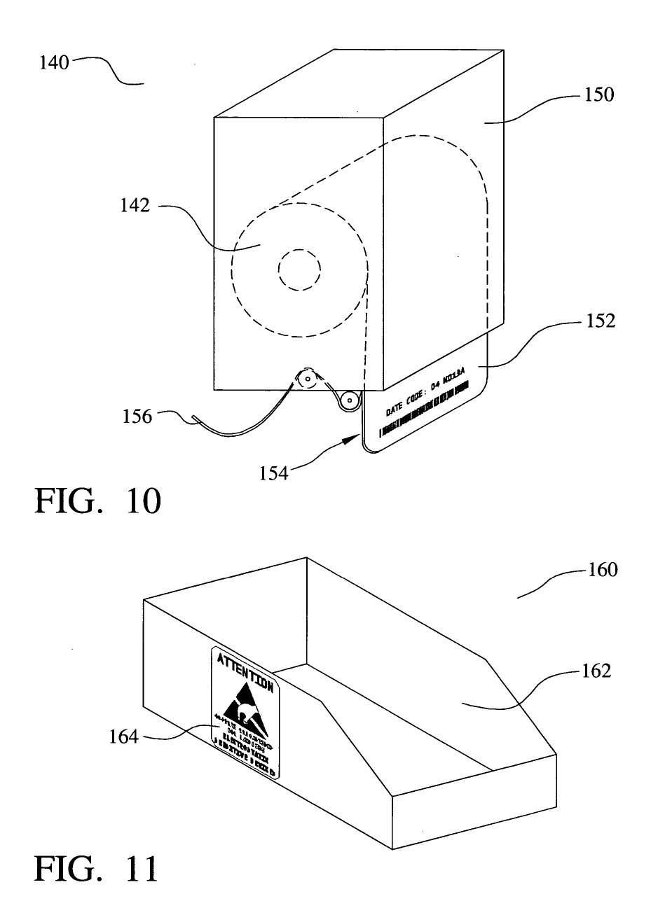

Referring now to FIG. 10, another preferred embodiment 140 for conductive loaded resin-based material labels of the present invention is shown. A rolled strip of conductive labels 142 is temporarily housed within a dispensing device 150. The dispensing device 150 contains the rolled supply of labels 142 until such time as the labels are individually removed for application to a desired surface such as the outside of a conductive container. The label 152 is shown in the current dispensing position. In addition to storing the labels, the dispensing device 150 also serves to remove the backing 156 from each label as the label reaches the current dispensing position. FIG. 10 shows the backing 156 as it is being removed from label 152 in the current dispensing position. The adhesive side 154 of label 152 is thus exposed. The label 152 is ready to be removed from the dispensing device 150 and applied to the desired surface. Removal of the label 152 from the dispensing device 150 is accomplished in one of several ways. In one preferred embodiment, the label is removed by hand by a human operator. In another preferred embodiment of the present invention, the dispensing device 150 includes a handle, not shown, which is held by a human operator. Holding the handle, the operator manipulates the dispensing device into position to apply the label 152 to the desired surface without directly touching the label by hand. In yet another preferred embodiment of the present invention, the dispensing device is rigidly mounted into position such as, for example, at a packaging/shipping station or a labeling station in a manufacturing facility. The label 152 is removed by hand by an operator. Alternately, the label 152 is removed by the product or container directly contacting the label 152 in such a manner as to remove the label from the device 150 and affix the label to the desired product or container. The dispensing device 150 is made in any one of many possible shapes/styles. In one preferred embodiment, the dispensing device itself also comprises conductive loaded resin-based material.

Referring now to FIG. 11, another preferred embodiment of the present invention is illustrated. A labeled tray assembly 160 is shown. In this embodiment, the conductive loaded resin-based material label 164 of the present invention is affixed to an exemplary conductive tray or bin 162. The conductive label 164 contains printed information. This printed information may include such items as a warning about handling ESD sensitive components, part name, part number, part size, date code, country of origin, tracking information, calibration, and other such pertinent information. In an alternate embodiment, the label 164 does not contain printed information. The purpose of this unprinted conductive label is to serve as a color-coded symbol to those familiar with an established color-coded informational system. For example, a red label could communicate a rush-status for a particular bin of components. Conductive loaded resin-based material labels of the present invention can be formed in many different colors, shapes, and sizes to fit the varying needs of different applications.

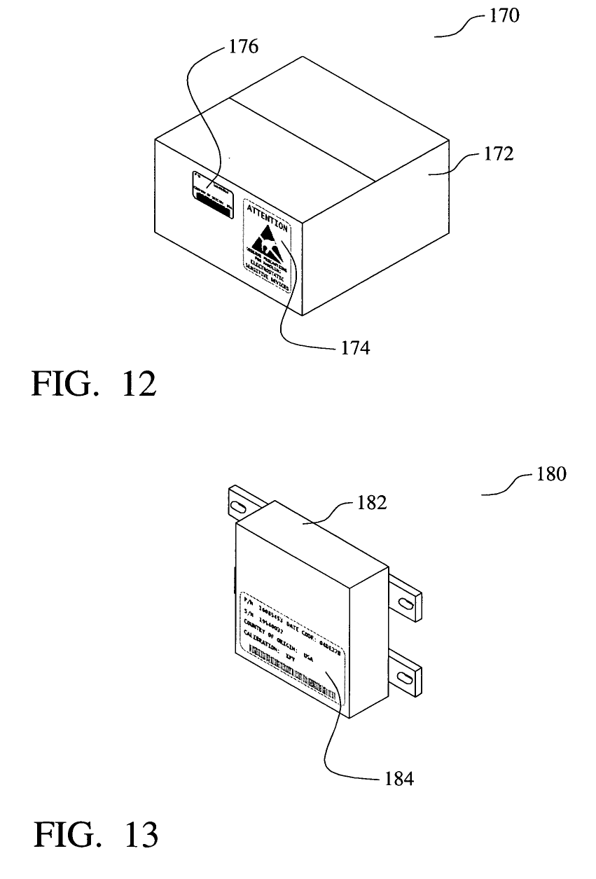

FIG. 12 shows yet another of the many end-use applications for conductive loaded resin-based material labels of the present invention. In this preferred embodiment 170, conductive labels 176 and 174 are adhered to an exemplary container 172. The container 172 is preferably electrically conductive or anti-static in nature. The conductive label 174 preferably displays information specific to the handling of ESD sensitive contents. The conductive label 176 preferably displays information specific to the contents of the container. This information may include, but is not limited to: part name, part number, part size, date code, country of origin, tracking information, calibration, and other such pertinent information. In an alternate embodiment, the label 176 does not contain printed information. The purpose of this unprinted conductive label is to serve as a color-coded symbol to those familiar with an established color-coded informational system. For example, a red label could communicate a rush-status for a particular shipment of components. Conductive loaded resin-based material labels of the present invention can be formed in many different colors, shapes, and sizes to fit the varying needs of different applications.

Referring now to FIG. 13, yet another preferred embodiment 180 of the present invention is illustrated. This embodiment 180 depicts a conductive label 184 adhered to a product housing 182. The product housing is preferably an electrically conductive housing which contains an ESD sensitive product. One example of such a housing 182 is the metal housing used to support and protect an electronic assembly. This exemplary housing 182 is often referred to as a “black box”. The conductive label 184 of the present invention comprises conductive loaded resin-based material. The conductive loaded resin-based material is inherently electrically conductive and thus does not allow potentially damaging electrostatic charges to build up on its surface. The conductive loaded resin-based material label 184 is also able to maintain electrical conductivity, legibility of printed information, and adhesive integrity over a wide range of temperatures. This makes the conductive loaded resin-based material label of the present invention ideal for use in labeling ESD sensitive housings and products. The conductive label 184 displays printed information which is pertinent to the product being labeled. In an alternate embodiment, an additional conductive loaded resin-based material label, not shown, is also adhered to the housing 182. This additional label does not contain printed information, but is rather a color-coded symbol. This color coded conductive label serves as an indication that a particular condition exists for the particular product upon which the label is placed. For example, a yellow circular label is adhered to a product that fails a particular electrical test and is in need of rework before it is salable. Similarly, a green circular label is adhered to the exemplary product after the product has been successfully repaired and is ready for shipment. This example is but one of many situations in which a color-coded conductive loaded resin-based material label is used to aid in the manufacture, test, shipment, and/or installation of ESD sensitive devices and/or assemblies.

Referring now to conductive loaded resin-based material labels in general, if a metal layer, not shown, is used on any of the conductive labels presented herein, the metal layer may be formed by plating or by coating. If the method of formation is metal plating, then the resin-based structural material of the conductive loaded, resin-based material is one that can be metal plated. There are many of the polymer resins that can be plated with metal layers. For example, GE Plastics, SUPEC, VALOX, ULTEM, CYCOLAC, UGIKRAL, STYRON, CYCOLOY are a few resin-based materials that can be metal plated. The metal layer may be formed by, for example, electroplating or physical vapor deposition.

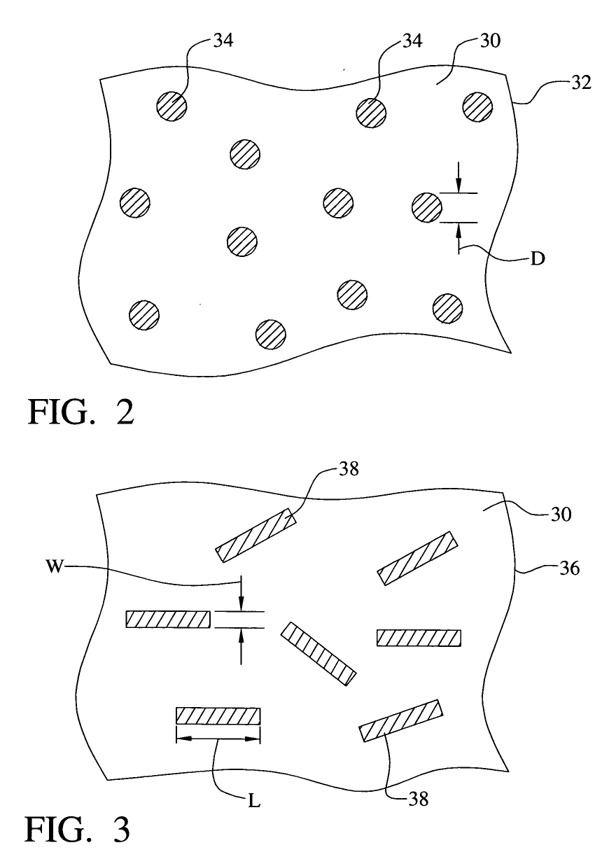

The conductive loaded resin-based material of the present invention typically comprises a micron powder(s) of conductor particles and/or in combination of micron fiber(s) homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

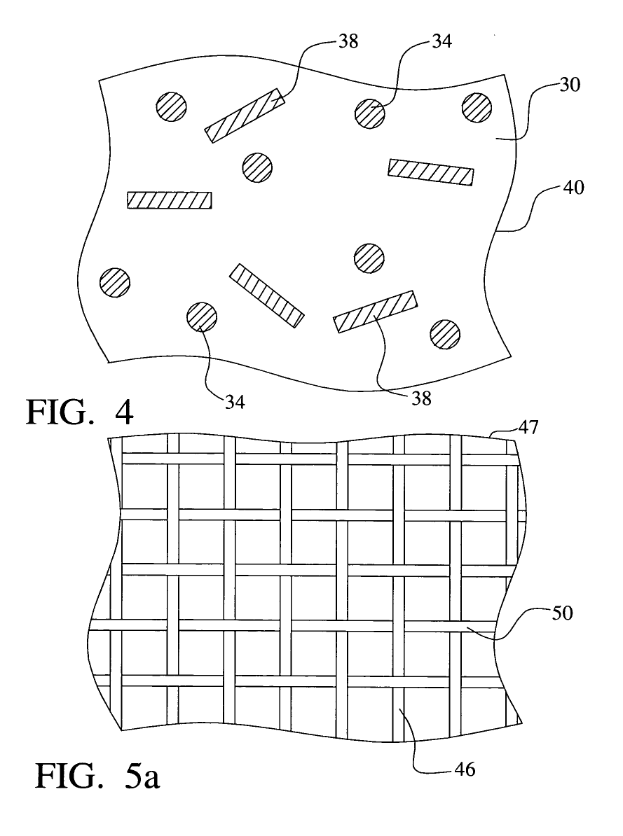

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The conductors used for these conductor particles 34 or conductor fibers 38 can be stainless steel, nickel, copper, silver, or other suitable metals or conductive fibers, or combinations thereof. These conductor particles and or fibers are homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 8-11 micron in diameter and lengths of 4-6 mm and comprising, by weight, about 30% of the total weight of the conductive loaded resin-based material will produce a very highly conductive parameter, efficient within any EMF spectrum. Referring now to FIG. 4, another preferred embodiment of the present invention is illustrated where the conductive materials comprise a combination of both conductive powders 34 and micron conductive fibers 38 homogenized together within the resin base 30 during a molding process.

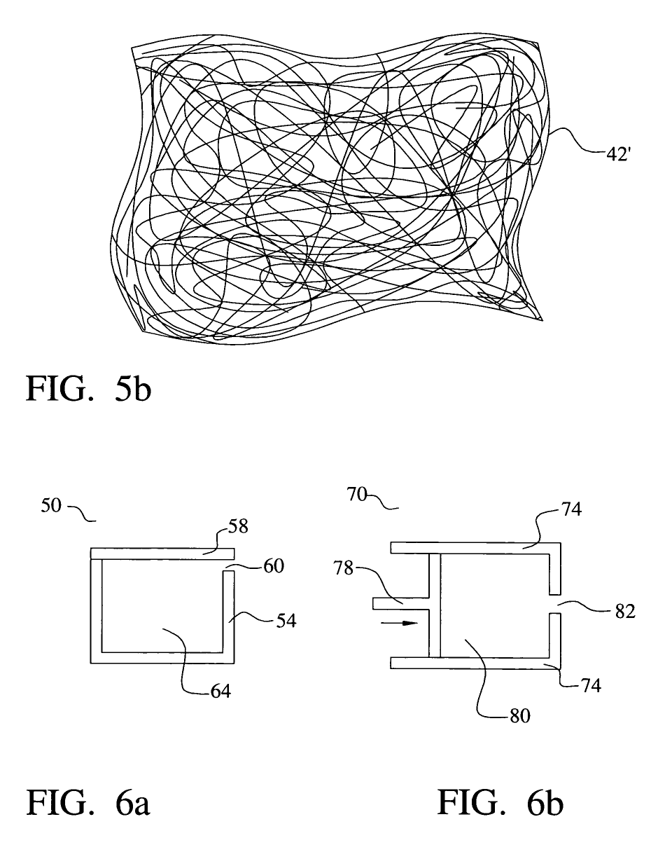

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

Anti-static labels formed from conductive loaded resin-based materials can be formed or molded in a number of different ways including injection molding, extrusion or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the homogenized conductive material cures by thermal reaction. The upper portion 58 and lower portion 54 of the mold are then separated or parted and the conductive devices are removed.

FIG. 6b shows a simplified schematic diagram of an extruder 70 for forming anti-static labels using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention. An extrusion molding apparatus is also capable of being configured in such a manner as to produce thin, sheet-like conductive loaded resin-based material for the formation of conductive labels of the present invention.

The advantages of the present invention may now be summarized. An effective conductive label is achieved. A method to form this conductive label is also achieved. The conductive label is molded of conductive loaded resin-based materials. The conductive loaded resin-based material provides a means of preventing and/or dissipating electrostatic charge such that electronic devices in contact with the label are protected against ESD. The conductive label is molded of conductive loaded resin-based material where the electrical characteristics can be altered or the visual characteristics can be altered by forming a metal layer over the conductive loaded resin-based material. Methods are shown to fabricate a conductive label from a conductive loaded resin-based material incorporating various forms of the material including in the form of a fabric.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

1. A conductive label device comprising:
a conductive loaded, resin-based material comprising conductive materials in a base resin host wherein said conductive loaded, resin-based material is capable of conducting electrical charge or current; and
informative shapes affixed to said conductive loaded, resin-based material.

2. The device according to claim 1 wherein the percent by weight of said conductive materials is between about 20% and about 50% of the total weight of said conductive loaded resin-based material.

3. The device according to claim 1 wherein the percent by weight of said conductive materials is between about 20% and about 40% of the total weight of said conductive loaded resin-based material.

4. The device according to claim 1 wherein the percent by weight of said conductive materials is between about 25% and about 35% of the total weight of said conductive loaded resin-based material.

5. The device according to claim 1 wherein said conductive materials comprise metal powder.

6. The device according to claim 5 wherein said metal powder is nickel, copper, or silver.

7. The device according to claim 5 wherein said metal powder is a non-conductive material with a metal plating.

8. The device according to claim 7 wherein said metal plating is nickel, copper, silver, or alloys thereof.

9. The device according to claim 5 wherein said metal powder comprises a diameter of between about 3 μm and about 12 μm.

10. The device according to claim 1 wherein said conductive materials comprise non-metal powder.

11. The device according to claim 10 wherein said non-metal powder is carbon, graphite, or an amine-based material.

12. The device according to claim 1 wherein said conductive materials comprise a combination of metal powder and non-metal powder.

13. The device according to claim 1 wherein said conductive materials comprise micron conductive fiber.

14. The device according to claim 13 wherein said micron conductive fiber is nickel plated carbon fiber, or stainless steel fiber, or copper fiber, or silver fiber or combinations thereof.

15. The device according to claim 13 wherein said micron conductive fiber has a diameter of between about 3 μm and about 12 μm and a length of between about 2 mm and about 14 mm.

16. The device according to claim 13 wherein the percent by weight of said micron conductive fiber is between about 20% and about 40% of the total weight of said conductive loaded resin-based material.

17. The device according to claim 13 wherein said micron conductive fiber is stainless steel and wherein the percent by weight of said stainless steel fiber is between about 20% and about 40% of the total weight of said conductive loaded resin-based material.

18. The device according to claim 17 wherein said stainless steel fiber has a diameter of between about 3 μm and about 12 μm and a length of between about 2 mm and about 14 mm.

19. The device according to claim 1 wherein said conductive materials comprise a combination of conductive powder and conductive fiber.

20. The device according to claim 19 wherein said conductive fiber is stainless steel.

21. The device according to claim 1 wherein said base resin and said conductive materials comprise flame-retardant materials.

22. The device according to claim 1 further comprising a metal layer overlying said conductive loaded resin-based material.

23. The device according to claim 1 wherein said informative shapes comprise an ink that is printed onto said conductive loaded, resin-based material.

24. The device according to claim 23 wherein said ink is conductive.

25. The device according to claim 1 wherein said informative shapes are molded into said conductive loaded, resin-based material.

26. The device according to claim 1 wherein said informative shapes are embossed into said conductive loaded, resin-based material after said conductive loaded, resin-based material is molded.

27. The device according to claim 1 wherein said conductive loaded, resin-based material is flexible.

28. The device according to claim 1 further comprising an adhesive layer bonded to said conductive loaded, resin-based material.

29. The device according to claim 28 wherein said adhesive layer is conductive.

30. The device according to claim 28 further comprising a release backing bonded to said adhesive layer.

31. The device according to claim 1 wherein said conductive loaded, resin-based material is further molded into a container.

32. A conductive label device comprising:
a conductive loaded, resin-based material comprising conductive materials in a base resin host wherein said conductive loaded, resin-based material is capable of conducting electrical charge or current and wherein the percent by weight of said conductive materials is between about 20% and about 50% of the total weight of said conductive loaded resin-based material; and
informative shapes affixed to said conductive loaded, resin-based material.

33. The device according to claim 32 wherein the percent by weight of said conductive materials is between about 20% and about 40% of the total weight of said conductive loaded resin-based material.

34. The device according to claim 32 wherein the percent by weight of said conductive materials is between about 25% and about 35% of the total weight of said conductive loaded resin-based material.

35. The device according to claim 32 wherein said conductive materials comprise metal powder.

36. The device according to claim 35 wherein said metal powder is a non-conductive material with a metal plating.

37. The device according to claim 32 wherein said conductive materials comprise non-metal powder.

38. The device according to claim 32 wherein said conductive materials comprise a combination of metal powder and non-metal powder.

39. The device according to claim 32 wherein said conductive materials comprise micron conductive fiber.

40. The device according to claim 39 wherein the percent by weight of said micron conductive fiber is between about 20% and about 40% of the total weight of said conductive loaded resin-based material.

41. The device according to claim 39 wherein said micron conductive fiber is stainless steel and wherein the percent by weight of said stainless steel fiber is between about 20% and about 40% of the total weight of said conductive loaded resin-based material.

42. The device according to claim 32 wherein said conductive materials comprise a combination of conductive powder and conductive fiber.

43. The device according to claim 42 wherein said conductive fiber is stainless steel.

44. The device according to claim 32 further comprising a metal layer overlying said conductive loaded resin-based material.

45. The device according to claim 1 wherein said informative shapes comprise an ink that is printed onto said conductive loaded, resin-based material.

46. The device according to claim 23 wherein said ink is conductive.

47. The device according to claim 1 wherein said informative shapes are molded into said conductive loaded, resin-based material.

48. The device according to claim 1 wherein said informative shapes are embossed into said conductive loaded, resin-based material after said conductive loaded, resin-based material is molded.

49. The device according to claim 1 wherein said conductive loaded, resin-based material is flexible.

50. The device according to claim 1 further comprising an adhesive layer bonded to said conductive loaded, resin-based material.

51. The device according to claim 28 wherein said adhesive layer is conductive.

52. The device according to claim 28 further comprising a release backing bonded to said adhesive layer.

53. The device according to claim 1 wherein said conductive loaded, resin-based material is further molded into a container.

54. A method to form a conductive label device, said method comprising:
providing a conductive loaded, resin-based material comprising conductive materials in a resin-based host;
molding said conductive loaded, resin-based material into said conductive label device; and
forming informative shapes affixed to said conductive loaded, resin-based material.

55. The method according to claim 54 wherein the percent by weight of said conductive materials is between about 20% and about 40% of the total weight of said conductive loaded resin-based material.

56. The method according to claim 54 wherein said conductive materials comprise micron conductive fiber.

57. The method according to claim 56 wherein said micron conductive fiber is nickel plated carbon fiber, or stainless steel fiber, or copper fiber, or silver fiber or combinations thereof.

58. The method according to claim 56 wherein said micron conductive fiber has a diameter of between about 3 μm and about 12 μm and a length of between about 2 mm and about 14 mm.

59. The method according to claim 56 wherein the percent by weight of said micron conductive fiber is between about 20% and about 40% of the total weight of said conductive loaded resin-based material.

60. The method according to claim 56 wherein said micron conductive fiber is stainless steel and wherein the percent by weight of said stainless steel fiber is between about 20% and about 40% of the total weight of said conductive loaded resin-based material.

61. The method according to claim 60 wherein said stainless steel fiber has a diameter of between about 3 μm and about 12 μm and a length of between about 2 mm and about 14 mm.

62. The method according to claim 54 wherein said conductive materials comprise conductive powder.

63. The method according to claim 54 wherein said conductive materials comprise a combination of conductive powder and conductive fiber.

64. The method according to claim 54 wherein said molding comprises:
injecting said conductive loaded, resin-based material into a mold;
curing said conductive loaded, resin-based material; and
removing said conductive label device from said mold.

65. The method according to claim 54 wherein said molding comprises:
loading said conductive loaded, resin-based material into a chamber;
extruding said conductive loaded, resin-based material out of said chamber through a shaping outlet; and
curing said conductive loaded, resin-based material to form said conductive label device.

66. The method according to claim 54 further comprising subsequent mechanical processing of said molded conductive loaded, resin-based material.

67. The method according to claim 54 further comprising overlying a layer of metal on said molded conductive loaded, resin-based material.

68. The method according to claim 54 wherein informative shapes are formed into said conductive loaded, resin-based material during said step of molding.

69. The method according to claim 54 wherein said step of forming said informative shapes comprises embossing said informative shapes into said conductive loaded, resin-based material.

70. The method according to claim 54 wherein said step of forming said informative shapes comprises printing a layer of ink onto said conductive loaded, resin-based material.

71. The method according to claim 70 wherein said ink is conductive.

72. The method according to claim 54 further comprising bonding a layer of adhesive onto said conductive loaded, resin-based material after said step of molding.

73. The method according to claim 72 further comprising bonding a layer of release backing onto said adhesive.

74. The method according to claim 72 wherein said adhesive is conductive.
